(19) United States
(12) Patent Application Publication
(10) Pub. No.: US 2019/0070660 A1
(43) Pub. Date: Mar. 7, 2019

(54) CHANNEL CLOSURE

(71) Applicant: ROLLS-ROYCE plc, London (GB)

(72) Inventors: Adrian L. HARDING, Derby (GB); David J. HUNT, Lichfield (GB)

(73) Assignee: ROLLS-ROYCE plc, London (GB)

(21) Appl. No.: 16/112,910

(22) Filed: Aug. 27, 2018

(30) Foreign Application Priority Data
Sep. 6, 2017 (GB) 1714291.0

(51) Int. Cl. B22D 19/00; F01D 5/18; B23P 21/00

(52) U.S. Cl. CPC B22D 19/0072; F01D 5/187; B23P 21/00; F05D 2230/211; F05D 2260/20; F05D 2240/12; F05D 2240/30; F05D 2230/23

(57) ABSTRACT

A method of bi-casting a first component (10) to a second component (11), wherein the first component comprises a channel (13) having an opening at a surface of the component, the method comprising inserting a pin (12) into the channel (13) to a closure position to block a cross-section of said channel, positioning the first and second components to be adjacent such that at least one space is defined between the first and second components, pouring liquid bi-cast metal (15) into the at least one space between the first component and the second component such that the first component is joined to the second component by the bi-cast metal and the pin is secured in the closure position.

### CROSS-REFERENCE TO RELATED APPLICATIONS

This application is based upon and claims the benefit of priority from British Patent Application No. GB 1714291.0, filed on 6 Sep. 2017, the entire contents of which are incorporated by reference.

### BACKGROUND

### Technical Field

The present disclosure concerns a method of closing a channel in a component, particularly when joining two components by bi-casting.

### Description of the Related Art

One of the components may be an aerofoil, such as a turbine blade for use in a gas turbine engine. Such turbine blades typically have a labyrinth, or network, of cooling channels within the blade body, through which air is passed to cool the blade. Such a blade is typically cast by an investment casting process. The outer geometry of the blade is typically set by a mould, and one or more cores are placed inside the mould to define the shape of the cooling channels. After casting, the core is removed. During casting, the core is held in place by a “core print”, which is a projection used to support the core. After casting, the core print is removed, which leaves a hole, or channel, or passage in the blade. It is generally desirable to close this hole, since it does not form part of the network of cooling channels, and could thus adversely affect the blade cooling.

Typically, the channel or hole left behind by the core print may be closed by welding the hole closed, if the core print is small. Alternatively, the channel may be closed by placing a sheet metal plate over the hole, and fixing the plate in place using a mechanical fixing, welding or brazing.

However, the above methods of closing the channel have disadvantages. Welding can lead to local distortion in the surface of the component, and may damage the area surrounding the weld. Thus, when welding is used, further treatment of the component may be necessary. If a brazed metal plate is used, more parts are required, which increases the cost and complexity of manufacture. If a metal plate is secured using mechanical fixings, these fixings can fall out, and damage the component or other surrounding components.

An improved method of closing the channel left behind by the core print may be desirable.

### SUMMARY

As disclosed herein, there is provided a method of bi-casting a first component to a second component, wherein the first component comprises a channel having an opening at a surface of the component, the method comprising inserting a pin into the channel to a closure position to block a cross-section of said channel, positioning the first and second components to be adjacent such that at least one space is defined between the first and second components, pouring liquid bi-cast metal into the at least one space between the first component and the second component such that the first component is joined to the second component by the bi-cast metal and the pin is secured in the closure position.

The pin may be secured in the closure position by contact with the bi-cast metal.

The channel may have an enlarged portion with a cross-section larger than the rest of the channel. When the pin is in the closure position, at least part of the pin may be inserted into at least part of the enlarged portion.

The method may further comprise a step of enlarging the cross-section of at least part of the channel to form the enlarged portion. The enlarging may be carried out by drilling, or any other suitable process.

The enlarged portion may include the opening of the channel. In other words, the enlarged portion may include the end of the channel.

The enlarged portion may intersect a region of the channel set apart from the opening of the channel. In other words, the enlarged portion may not include the end of the channel. The enlarged portion may be enlarged through the wall of the channel part of the way down the channel.

The pin may be inserted in a direction substantially parallel to the direction of the channel at the enlarged portion.

The pin may be inserted in a direction transverse to the direction of the channel at the enlarged portion.

The cross-section of the part of the pin which abuts the end of the enlarged portion may be larger than the cross-section of the channel at the interface of the enlarged portion and the rest of the channel. In other words, the part of the pin which is at the interface between the enlarged portion and non-enlarged part of the channel may be wider than the non-enlarged part of the channel.

At least one cross-section of the pin may be smaller than the cross-section of the enlarged portion of the channel. A void may be defined between the pin and the enlarged portion when the pin is in the closure position. The void may be filled by the bi-cast metal during the step of pouring.

Contact between the pin and the channel may seal the channel.

Contact between the pin, the bi-cast metal and the channel may seal the channel.

The first component may be an aerofoil. The aerofoil may be a vane, a rotor blade, a stator blade or any other type of aerofoil.

As disclosed herein, there is also provided a bi-cast assembly comprising a first component comprising a channel having an opening at a surface of the component, a second component, a pin and bi-cast metal between the first component and the second component, wherein the pin is located inside the channel at a closure position to block a cross-section of said channel, the first component is joined to the second component by the bi-cast metal, securing the pin in the closure position.

The pin may be secured in the closure position by contact with the bi-cast metal.

The channel may have an enlarged portion with a cross-section larger than the rest of the channel. When the pin is in the closure position, at least part of the pin may be inserted into at least part of the enlarged portion

The enlarged portion may include the opening of the channel.

The enlarged portion may intersect a region of the channel set apart from the opening.

The cross-section of the part of the pin which abuts the end of the enlarged portion may be larger than the cross-section of the channel at the interface of the enlarged portion and the rest of the channel.

Contact between the pin and the channel may seal the channel.

Contact between the pin, the bi-cast metal and the channel may seal the channel.

The first component may be an aerofoil.

As disclosed herein, there is also provided a method of joining a first component to a second component using a joining material that can exist in at least a liquid or paste state and a solid state, wherein the first component comprises a channel having an opening at a surface of the component, the method comprising inserting a pin into the channel to a closure position to block a cross-section of said channel, positioning the first and second components to be adjacent such that at least one space is defined between the first and second components, injecting the joining material in the liquid or paste state into the at least one space between the first component and the second component such that the first component is joined to the second component and the pin is secured in the closure position once the joining material is in the solid state.

As disclosed herein, there is also provided an assembly comprising a first component comprising a channel having an opening at a surface of the component, a second component, a pin, and joining material between the first component and the second component wherein the pin is located inside the channel at a closure position to block a cross-section of said channel, the first component is joined to the second component by the joining material, securing the pin in the closure position.

Where variations and arrangements using bi-cast metal are described herein, it will be understood that when a different joining material that can exist in a liquid or paste state is used, corresponding or equivalent variations and arrangements are possible using the other joining materials as described herein.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF DRAWINGS

Embodiments will be more clearly understood from the following description, given by way of non-limitative example only, with reference to the accompanying drawings in which:

FIG. 1 illustrates a schematic of a typical gas turbine engine;

FIG. 2 illustrates a component with a core print channel;

FIG. 3 illustrates the insertion of a pin into the core print channel;

FIG. 4 illustrates the component positioned adjacent to a second component, with the pin in a closure position;

FIG. 5 illustrates the component bi-cast to a second component, with the pin in a closure position;

FIG. 6 shows a bi-cast assembly with a top insert pin;

FIG. 7 shows a bi-cast assembly with a side insert pin;

FIG. 8 shows a bi-cast assembly with a tapered side insert pin;

FIG. 9 shows a bi-cast assembly with a flared enlarged portion and a side insert pin;

FIG. 10 shows a bi-cast assembly with a pin with a stepped cross-section;

FIG. 11 shows a perspective view of the pin with a stepped cross-section as shown in FIG. 10;

FIG. 12 shows a bi-cast assembly with a pin with a notch;

FIG. 13 shows a perspective view of the pin with a notch as shown in FIG. 12;

FIG. 14 shows a bi-cast assembly in which the bi-cast groove is located on the pin;

FIG. 15 shows a bi-cast assembly in which part of the channel is merged with the bi-cast groove; and

FIG. 16 shows a bi-cast assembly in which one end of the pin abuts a second component.

### DETAILED DESCRIPTION

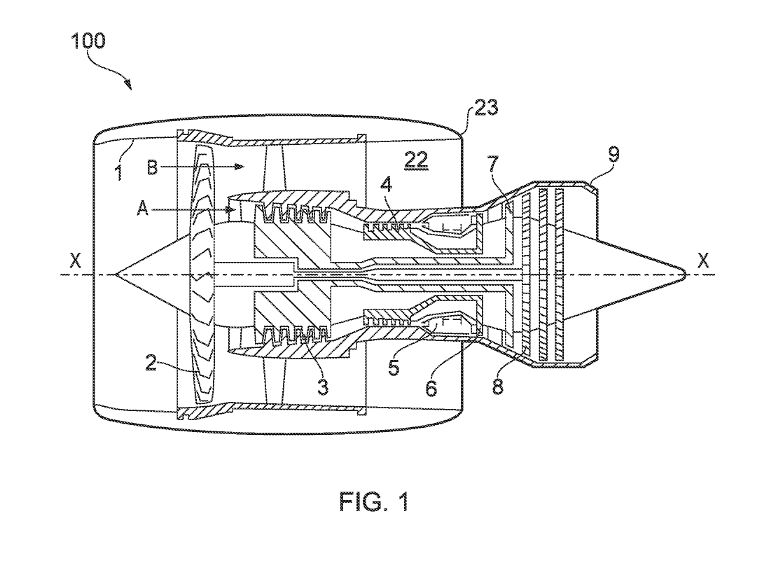

With reference to FIG. 1, a ducted fan gas turbine engine generally indicated at 100 has a principal and rotational axis X-X. The engine 100 comprises, in axial flow series, an air intake 1, a compressive fan 2 (which may also be referred to as a low pressure compressor), an intermediate pressure compressor 3, a high-pressure compressor 4, combustion equipment 5, a high-pressure turbine 6, an intermediate pressure turbine 7, a low-pressure turbine 8 and a core exhaust nozzle 9. The engine also has a bypass duct 22 and a bypass exhaust nozzle 23.

The gas turbine engine 100 works in a conventional manner so that the air entering the intake 1 is accelerated by the fan 2 to produce two air flows; a first air flow A into the intermediate pressure compressor 3 and a second air flow B which passes through the bypass duct 2 to provide propulsive thrust. The intermediate pressure compressor 3 compresses the air flow A directed into it before delivering that air to the high pressure compressor 4 where further compression takes place. The compressed air exhausted from the high-pressure compressor 4 is directed into the combustion equipment 5 where it is mixed with fuel and the mixture combusted. The resulting hot combustion products then expand through, and thereby drive the high, intermediate and low-pressure turbines 6, 7 and 8 before being exhausted through the nozzle 9 to provide additional propulsive thrust. The high, intermediate and low-pressure turbines 6, 7, 8 respectively drive the high and intermediate pressure compressors, 4, 3 and the fan 2 by suitable interconnecting shafts.

The fan 2, the high and intermediate pressure compressors, 4, 3, and the high, intermediate and low-pressure turbines 6, 7, 8 include aerofoil components, which may be, for example, rotor blades, stator blades, or vanes.

Such aerofoil components can be attached to other components (such as shrouds or hubs) by a bi-casting process. This is a process in which liquid metal, known as bi-cast metal, is poured into a space between two components, filling the space. The bi-cast metal may join the two components once it has solidified. Depending on the choice of materials, the bi-cast metal may not adhere to the components that it joins together. Thus, the components may be provided with bi-cast grooves, which protrude into the body of the respective components on which they are formed. When the two components are positioned adjacent to each other, the two grooves line up with each other, and create a space between the two components. When the bi-cast metal is poured in and solidified, the space formed by the two grooves is filled. The bi-cast metal forms a plug, or key, which may stop the components moving relative to each other, even if the bi-cast metal does not adhere to the surfaces of the components.

Aerofoil components are often produced by investment casting, in which a core insert is used to define the shape of cooling passages in the component. The core insert may be made of a ceramic material. The core insert is placed in a mould which defines the outer geometry of the component, and molten metal is poured in. The core insert is then removed, for example by leaching. During the casting process, the core insert is held in place by a projection from the mould known as a core print. When the core print is removed, it leaves behind a hole, or passage, or channel in the body of the component. Generally this channel does not form part of the network of cooling channels, and it may be desirable to close, block or seal this channel.

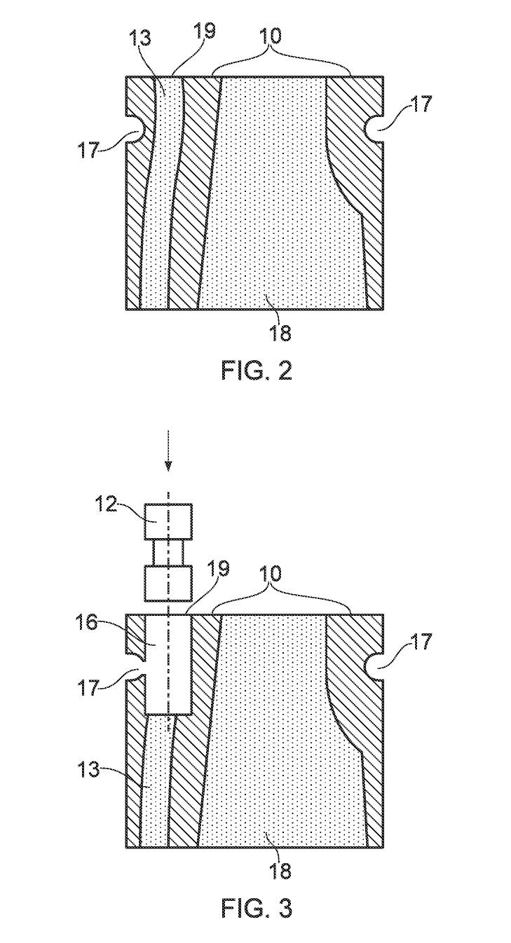

The present disclosure relates to a method of bi-casting an aerofoil 10 to a second component 11. As shown in FIG. 2, the aerofoil 10, may have a main intake passage 18, a channel (core print passage) 13, and bi-cast grooves 17. The main intake passage is part of the network of cooling channels, and is formed around the core during investment casting. The channel 13 is formed when the core print is removed, as described above. The channel has an opening 19 at the surface of the aerofoil 10.

The second component 11 may be a shroud, for example for use in a stator vane ring, a hub, or any other component to which the aerofoil is to be joined.

The method of bi-casting the aerofoil 10 to the second component 11 includes inserting a pin 12 into the channel such that the pin blocks the channel. In other words, the pin is inserted to a closure position in which the pin closes, or blocks the channel.

The aerofoil 10 and the second component 11 are positioned adjacent to each other so that a space is defined between the first and second components. The space may include the bi-cast groove 17 of the aerofoil 10, and a corresponding groove on the second component 11. The corresponding groove on the second component may be positioned such that it aligns with the bi-cast groove 17 of the aerofoil 10 the two components are aligned in the position in which they are to be joined.

Liquid bi-cast metal 15 is then poured into the space between the two components. When the bi-cast metal solidifies, it serves two purposes. First, the bi-cast metal joins the two components together, as set out above. Second, this joining of the first component to the second component by the bi-cast metal secures the pin 12 in the closure position, thus blocking the channel.

Thus, there is provided a method of bi-casting a first component (such as an aerofoil as described above) to a second component, which also results in the closure of the core print channel. In other words, the channel left by the removal of the core print after casting of a component can be closed at the same time as the component is bi-cast to another component. This may result in easier and cheaper manufacture, with fewer parts and processes required to close the core print channel.

As described above and below, the method as herein described may be used to close the channel in an aerofoil and join the aerofoil to another component. However, its use is not limited to joining an aerofoil to another component. It may be used for joining any two components where it is additionally desired to close a channel in one of the components.

As described herein, the components may be joined by bi-casting using liquid metal. However, the joining process may also be a process other than bi-casting using liquid metal, such as injection (which may be a staged injection) of a different joining material that can exist in a liquid or paste state during the joining process and a solid state after completion of the joining process. Examples of other suitable joining materials include a cement, a ceramic paste, an epoxy resin or a plastic. In a bi-cast process, the liquid metal becomes solid as it cools. With other joining materials, the transition to the solid state may occur over time as a result of curing, or the nature of the joining material used may require a further processing step to cause transition to the solid state.

FIGS. 2-5 show an example of an arrangement of the method described above. As described above, the aerofoil 10 has a main intake passage 18, a channel (core print passage) 13, and bi-cast grooves 17.

In this arrangement, a portion of the channel 13 is enlarged, for example by drilling, to form an enlarged portion 16. The enlarged portion 16 has a cross-section which is larger than the cross-section of the rest of the channel. The enlarged portion 16 may be formed such that it intersects with the bi-cast groove. This is shown in FIG. 3. In other words, the enlarged portion breaks through the wall of the channel 13, such that it joins up with the bi-cast groove 17.

As shown in FIG. 3, a pin 12 is inserted into the enlarged portion 16. The position in which the pin 12 is inserted into the enlarged portion will be referred to as the closure position. That is, the pin 12 closes, or blocks the channel 13 when it is inserted into the enlarged portion 16 of the channel.

The pin is inserted through the opening 19 of the channel in the surface of the component substantially parallel to the direction of the channel at the enlarged portion. In other words, the pin is inserted from above, in the orientation shown in FIG. 3. That is, the channel is generally elongate, and thus extends in a certain direction (which may not be the same along the whole length of the channel). However, because the length of the enlarged portion is short compared to the total length of the channel, a primary direction of the channel at the enlarged portion can be understood. Thus, the pin may be inserted in a direction which is parallel to the primary direction of the channel at the enlarged portion.

In this arrangement, the part of the pin which abuts the interface between the enlarged portion 16 and the rest of the channel 13 has a larger cross-section than the non-enlarged part of the channel 13 at the interface. By virtue of the cross-section of the surface of the pin being larger than the non-enlarged part of the channel, contact at the interface between the surface of the pin 12 and the surface of the material surrounding the entry into the non-enlarged part of the channel blocks the channel. The arrangement may also temporarily hold the pin in place before the bi-cast metal 15 is poured in.

In the arrangement shown in FIGS. 3, 4 and 5, the pin is a waisted pin (i.e. a pin with a dumbbell shape). That is, the pin 12 has three different portions along its length. The cross-section of the middle portion is smaller than that of the two outer portions. The cross-section of the middle portion is also narrower than the cross-section of the enlarged portion 16. Thus, when the pin is inserted into the enlarged portion 16, there is a gap, or void 20, between the walls of the enlarged portion 16 and the middle portion of the pin. The middle portion of the pin need not have the same cross-sectional shape as the rest of the pin.

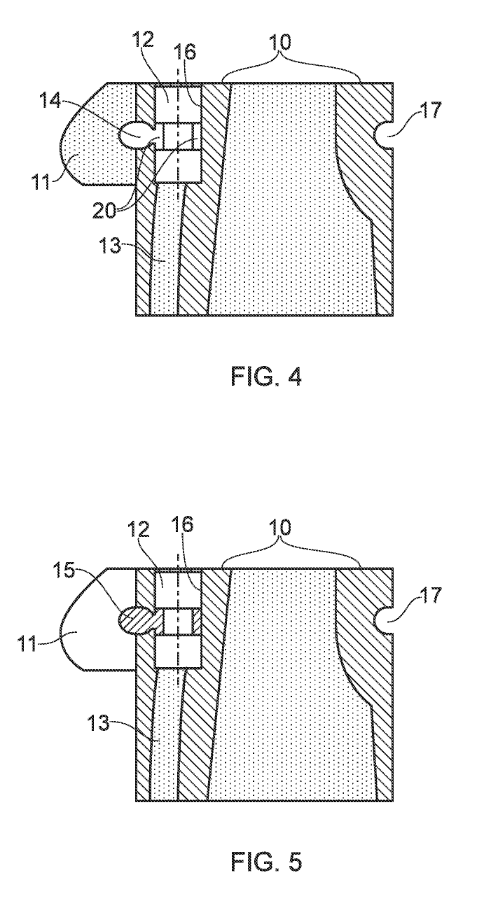

As shown in FIG. 4, to form the bi-cast assembly, the aerofoil 10 is positioned adjacent to a second component 11, such that a space 14 is defined between the aerofoil 10 and the second component 11. The space 14 includes a bi-cast groove 17 of the aerofoil 10, and an equivalent groove on the second component, positioned to adjoin the bi-cast groove 16 when the two components are positioned adjacent to each other in the desired position. The space may also include the void 20, or gap, between the walls of the enlarged portion 16 and a portion of the pin 12.

Liquid bi-cast metal 15 is then poured into the space between the aerofoil 10 and the second component 11. When the liquid bi-cast metal 15 is poured into the space 14 between the aerofoil 10 and the second component 11, the bi-cast metal 15 fills the space 14 between the two components, and also fills the void 20 between the middle portion of the pin and the enlarged portion 16. The hatched lines in FIG. 5 show the bi-cast metal filling the space between the two components and the void.

In this arrangement, the bi-cast metal 15 extends continuously between, and fills the gap previously formed between, the bi-cast groove on the second component 11, the bi-cast groove 17 on the aerofoil 10 and the void 20. The first component 10, the second component 11 and the pin 12 are thus held together by the bi-cast metal. In other words, the aerofoil 10 is joined to the second component 11 by the bi-cast metal, and the pin 12 is secured in position by contact with the bi-cast metal 15.

This contact seals the channel. The pin is secured in the closure position, or locked in position, by virtue of the bi-cast metal 15 surrounding its middle portion (i.e. filling the void between the middle portion of the pin 12 and the walls of the enlarged portion 16) and being connected to the aerofoil 10 and second component 11. The sealing may prevent air from leaking into the network of cooling passages through the core print channel. Such air leakage may bypass the cooling network and make the blade cooling less effective. If there is an imperfect fit between the pin and the core print passage, a small amount of air may still be able to leak. However, a seal which allows a small amount of air to leak may still be sufficient to prevent the blade cooling from being affected. Such a seal may still prevent bi-cast material from leaking into the channel during the bi-cast process, even if a small amount of air can leak thereafter.

The process set out above means that the channel 13 left behind by the core print after casting can be closed and sealed during the bi-cast process. Conventionally, the core print must be provided with clearance from the bi-cast groove so that the liquid bi-cast metal does not enter the core print passage during bi-casting. This reduces the space available for the cooling passages in the aerofoil. In the arrangement described above, the core print passage (i.e. the channel 13) may intersect with the bi-cast groove 17. This may mean that there is more space for other openings into the blade, such as the main inlet passage 18. This may result in more effective cooling of the aerofoil.

As described in relation to FIGS. 3, 4 and 5 above, a portion of the channel 13 is enlarged to form an enlarged portion 16. However, the channel and pin may be shaped such that an enlarged portion is not used. In other words, the channel and pin may be formed such that the pin can be inserted into the channel, and then secured in place by the bi-cast metal, without any enlargement of the channel being necessary.

As set out above, the enlarged portion 16, if one is present, may be formed by drilling. Alternatively, the enlarged portion 16 may be formed by any other suitable means, or may be pre-formed by the shape of the core print protection during investment casting, such as electro-discharge machining (EDM), or electro-chemical machining (ECM).

It will be noted that, in the arrangement described above and shown in FIGS. 3 and 4, the pin 12 is first inserted to the closure position, and the aerofoil 10 and second component 11 are then positioned adjacent to each other. However, the step of inserting the pin 12 to the closure position and positioning the aerofoil 10 and the second component 11 adjacent to each other can be carried out in the reverse order. In other words, it is also possible that the aerofoil 10 and second component 11 are first positioned adjacent to each other, and the pin 12 subsequently inserted into the enlarged portion 16 to the closure position.

As set out above, and as shown in FIG. 3, the enlarged portion includes the end of the channel 13. However, as set out below, other arrangements are possible in which the enlarged portion does not include an opening 19 of the channel at a surface of the aerofoil 10.

As set out above, the pin may be a waisted pin, allowing the bi-cast metal 15 to surround the narrower portion. The pin may also be a slotted pin, for example with a slot which aligns with the bi-cast groove 17 when the pin is inserted. The slot thus forms part of the space between the two components. In such an arrangement, the bi-cast metal flows into the slot when it is poured into the space between the two components, thus securing the pin when it solidifies.

As set out above, and as shown in FIG. 3, the pin is inserted substantially parallel to the direction of the channel at the enlarged portion. However, as set out below, other arrangements are possible in which the pin is inserted in a direction transverse to, or substantially perpendicular to, the direction of the channel at the enlarged portion (that is, from the side when viewed in the orientation shown in FIG. 3).

As set out above, in the arrangement shown in FIGS. 3 and 4, the pin is a waisted pin (i.e. a pin with a dumbbell shape). However, the pin 12 may have different shapes. Arrangements using pins with different shapes are set out below.

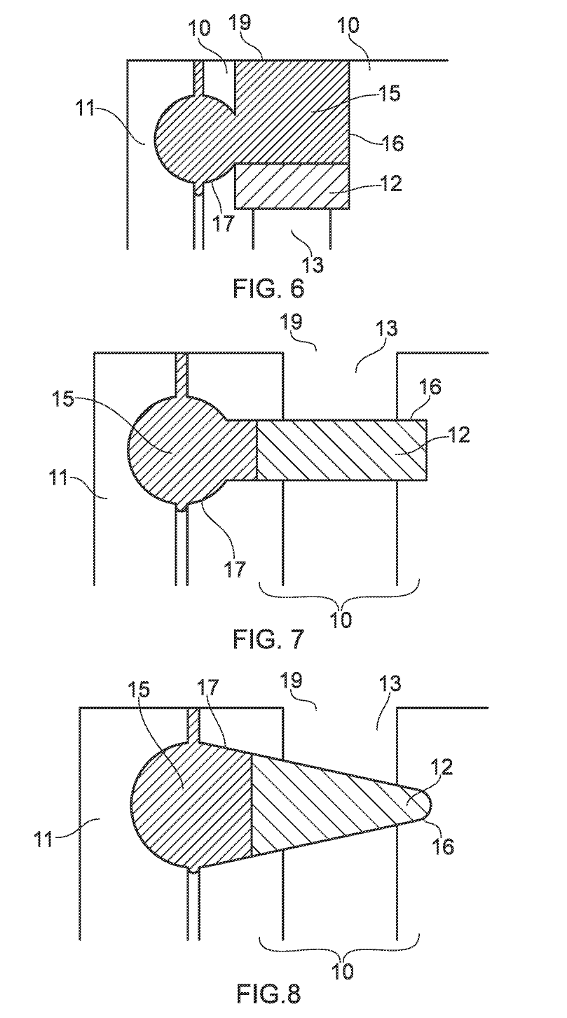

In the arrangement shown in FIG. 6, a similar method to the previous arrangement of blocking the channel 13 and bi-casting the two components together is used. As in the arrangement described above, the pin is inserted substantially parallel to the direction of the channel. However, in the arrangement shown in FIG. 6, a waisted pin is not used.

In this arrangement, the pin has a constant cross-section along its length, and, as in the arrangement shown in FIGS. 2 to 5, is inserted into the channel from the opening 19 at the surface of the channel (i.e. from above in the orientation shown in the Figures). The cross-section of the pin is larger than the cross-section of the non-enlarged part of the channel 13. This can be thought of as being equivalent to the bottom portion of the waisted pin of the previous arrangement (i.e. the portion of the pin at the interface between the enlarged portion 16 and the rest of the channel).

In this arrangement, the enlarged portion intersects with the bi-cast groove 17 (i.e. breaks through the wall of the channel into the bi-cast groove).

To form the bi-cast assembly, the aerofoil 10 and the second component 11 are positioned adjacent to each other to form a space between them, as in the previous arrangement. When the bi-cast metal 15 is poured in, it can be poured into the space between the aerofoil 10 and the second component 11, and/or can be poured into the enlarged portion through the opening 19 of the channel.

If the bi-cast metal 15 is poured into the space between the aerofoil 10 and the second component 11, it then flows into the enlarged portion 16 of the channel 13 through the part where the bi-cast groove 17 intersects the enlarged portion. It thus covers the pin across its cross-section from above, securing the pin 12 in position. It also joins the aerofoil 10 the second component 11 by virtue of extending into the space between the two components. The bi-cast metal 15 can be also poured into the enlarged portion 16, and then flow into the space between the two components.

In this arrangement, the bi-cast metal 15 does not surround part of a pin with a narrower cross-section, but rather secures the pin 12 in place by covering it from above in the orientation shown in FIG. 2. In other words, the middle (narrower) portion and one of the outer portions of the waisted pin are omitted, and the pin is covered across its whole cross section by the bi-cast metal 15 to secure it, rather than a portion being surrounded.

In the arrangements shown in FIGS. 3-6, the pin 12 is inserted through the opening 19 at the end of the channel 12. These can be regarded as “top insert” arrangements. However, other arrangements are possible in which the pin is instead inserted through the wall of the channel. In other words, the enlarged portion 16 of the channel 13 extends across and beyond the cross-section of the channel 13 through the wall of the channel. Examples of such arrangements are described below and shown in FIGS. 7-10. In these arrangements, the enlarged portion does not include the region of the opening 19 of the channel 13 at the surface of the aerofoil 10. Instead, the enlarged portion is formed by drilling (or any other suitable method) across the channel, rather than from the opening 19. These arrangements will be referred to as “side insert” arrangements.

In the side insert arrangements, the enlarged portion of the channel is oriented transverse to, or perpendicular to, the primary direction of the channel at the enlarged portion. This means that the pin 12 is inserted to the closure position in a direction which is transverse to the direction of the channel at the enlarged portion, rather than substantially parallel to the direction of the channel at the enlarged portion, as in the arrangements shown in FIGS. 2-6.

To form the bi-cast assembly, the pin 12 is inserted, and the aerofoil 10 and the second component 11 are positioned adjacent to each other to define a space between them, as in the preceding arrangements. The liquid bi-cast metal is poured into the space, and fills the space. It will be noted that, in these side insert arrangements, a surface of the pin 12 may form one of the boundaries of the space to be filled by the bi-cast metal. This means that, once the bi-cast metal 15 has solidified, the pin is held in position by the bi-cast metal.

The arrangements shown in FIGS. 7-10 may have the advantage that, if the bi-cast material 15 happens to fracture at the location where it intersects with the bi-cast groove, the pin 12 will not fall out.

Various side insert arrangements are possible. As shown in FIG. 7, the pin 12 may have a uniform cross-section along its length. For example, it may have a circular cross-section. This may facilitate the formation of the enlarged portion transverse to the direction of the channel in which it is to fit. It may also facilitate provision of a close fit between the pin 12 and the enlarged portion 16 of the channel. As described above, the pin 12 is then secured in place by the bi-cast material from the side. This may mean that no bi-cast material enters the channel 13.

In an arrangement with a side insert pin, the pin may have a non-uniform cross-section along its length. For example, the cross-section of the pin may vary along its length. In an arrangement, the pin may be tapered, as shown in FIG. 8. It may have a conical or frustoconical shape. This may result in the pin being temporarily held in place more effectively before the bi-cast metal is poured in, due to it being “wedged” into position. This arrangement is shown in FIG. 8. It may also facilitate insertion of the pin.

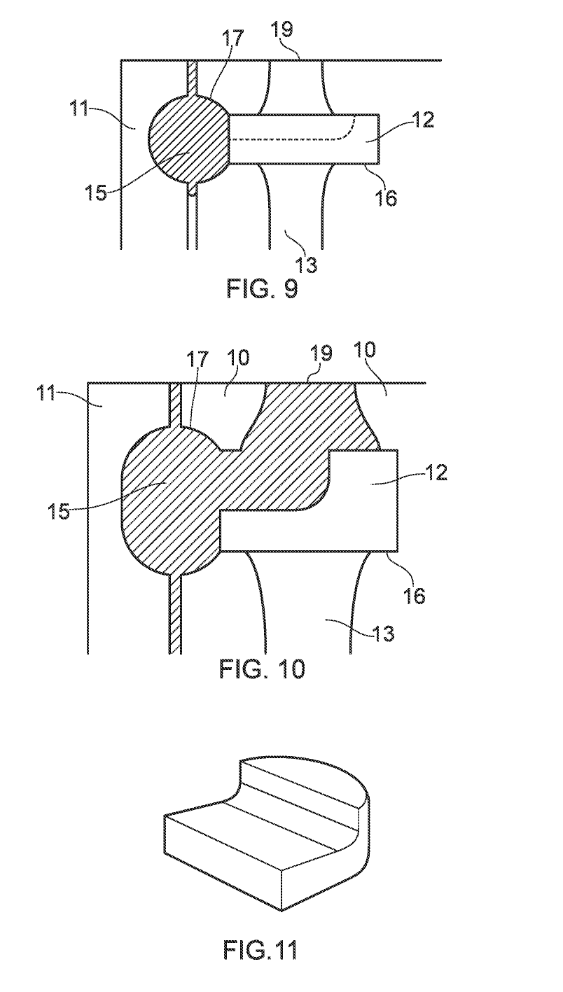

In another arrangement, the channel 13 may not have a uniform cross-section, but rather diverge and converge such that a “bulge” is present in the channel 13. The bulge may be formed during casting by the shape of the core or core print. As shown in FIGS. 9 and 10, the enlarged portion 16 may be formed at the point where the cross-section of the channel 13 is largest. In this arrangement, the pin may have a uniform cross-section along its length, similar to that shown in FIG. 7. In an alternative, not depicted in the Figures, the pin in such an arrangement may have a non-uniform cross-section along its length, such as a pin as shown in FIG. 8. Again, as in the arrangements shown in FIGS. 7 and 8, the pin is secured in position by the bi-cast metal from the side. These arrangements may mean that less material is required to be removed to form the enlarged portion 16. This in turn may simplify manufacture. In the arrangement shown in FIG. 10, the converging part of the channel 13 may also mean that the bi-cast metal cannot fall out once it has solidified.

In an arrangement, the pin 12 may be secured by the bi-cast metal 15 from both above (as in the arrangement of FIG. 6) and from the side (as in the arrangements of FIGS. 7-9). Examples of arrangements of this type are shown in FIGS. 10-13.

One example of such an arrangement is shown in FIG. 10. In this arrangement, the pin has a step in cross-section. The surface of the pin which abuts the interface between the enlarged portion 16 and the rest of the channel 13 is larger than the opening of the channel 13 into the non-enlarged part of the channel. This interface secures the pin 12 in place before the bi-cast metal 15 is present. A part of the pin which does not abut the interface is smaller, resulting in a cross section with a step change.

As in the previous arrangements, the pin is inserted from the side, and the two components are positioned adjacent such that a space is formed between them. When the bi-cast metal 15 is poured into the space, it flows into the space including the bi-cast groove, and into the part of the enlarged portion which is not filled by the pin. Thus, when the bi-cast metal solidifies, the pin 12 is secured in position both from the side and from above where the cross-section of the pin changes. This may result in the pin being more effectively secured. Further, in the arrangement of FIG. 10, the bi-cast metal 15 may flow into the space above the pin and fill the space. This may result in a more effective seal due to more of the channel opening 19 being filled. It will be noted that, in FIG. 10, the bi-cast material 15 is illustrated as filling all of the space above the pin. However, it is possible that only part of the space above the pin is filled.

FIG. 11 shows a perspective view of the pin used in the arrangement of FIG. 10.

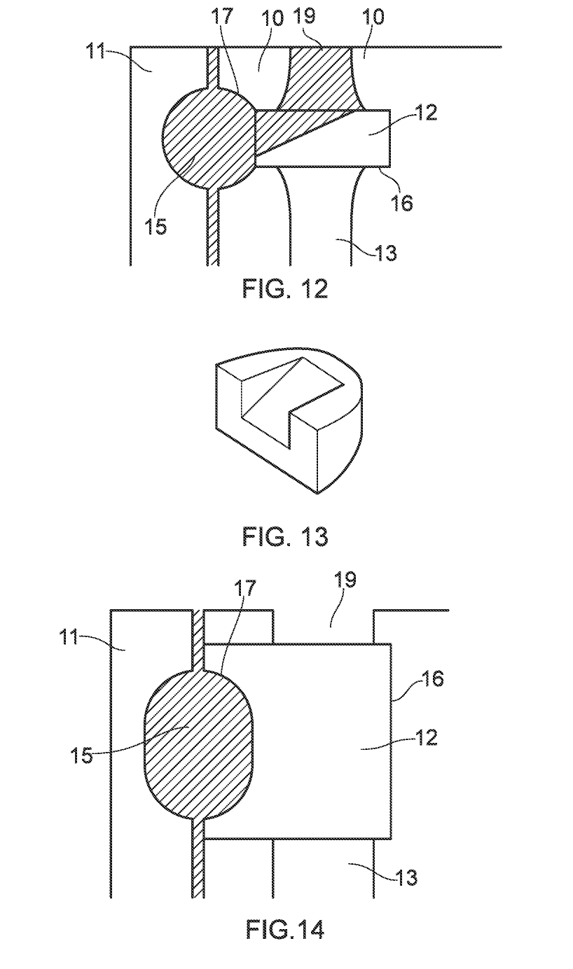

Another example of an arrangement where the pin 12 is secured by the bi-cast metal 15 from both above and from the side is shown in FIG. 12. This arrangement is similar to that shown in FIG. 10, but uses a notch in the pin instead of a stepped cross-section. In this arrangement, the pin 12 has a notch or groove cut between the surface which abuts the bi-cast metal and the surface which faces the opening 19 of the channel 13 when the pin is in the closure position (i.e. the upper surface in the orientation of FIG. 12). Thus, when the bi-cast metal 15 is poured into the space between the two components, it can flow through the notch and into the space above the pin. It will be noted that, in FIG. 12, the bi-cast material 15 is illustrated as filling all of the space above the pin. However, it is possible that only part of the space above the pin is filled.

FIG. 13 shows a perspective view of the pin used in the arrangement of FIG. 12. As shown in FIG. 13 (and in the cross-section of FIG. 12), the notch may have a sloping surface between the two surfaces. However, other shapes are possible, such as a step shape, so that the notch has a shape similar to the step shown in FIG. 11. Instead of a notch, a feed hole which joins the two surfaces may also be used, allowing the bi-cast metal to flow into the space above the pin 12.

In some arrangements, at least part of the pin 12 may be in contact with the second component 11. For example, in a side insert arrangement, when the pin is in the closure position, a part of the pin 12 may extend to one side of, or to both sides of, the space between the aerofoil 10 and the second component 11 such that part of the pin touches the second component. In these arrangements, even if the bi-cast metal 15 fractures, both the pin 12 and the bi-cast metal 15 may be prevented from falling out. In some such arrangements, the bi-cast groove 17 may be located on the pin, rather than on the aerofoil 10. An example of such an arrangement is shown in FIG. 14.

In some arrangements, the channel 13 may be merged with the bi-cast groove 17. In other words, there may be no portion of wall of the aerofoil 10 between the channel 13 and the second component 11. This may be achieved by arranging the core print such that, when investment casting is performed and the core print removed, part of the channel 13 and the bi-cast groove 17 are formed as one space.

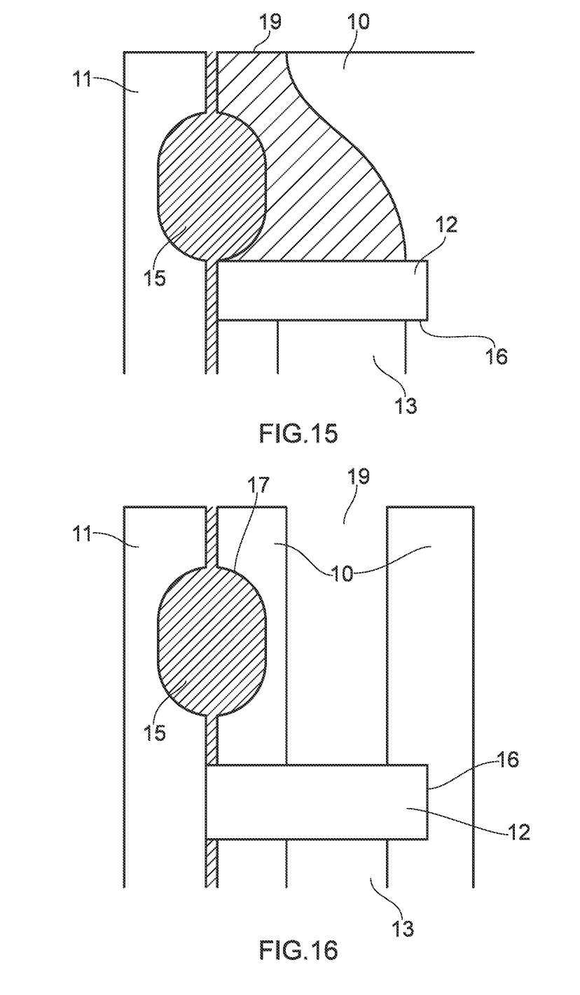

An example of such an arrangement is shown in FIG. 15. In this arrangement, the part of the channel 13 which is merged with the bi-cast groove 17 can also be considered itself to be part of the bi-cast groove, because this portion fills with the bi-cast metal and forms part of the space between the aerofoil 10 and the second component. Alternatively, in this arrangement, it can be considered that the aerofoil 10 does not have a bi-cast groove 17, with part of the channel instead forming the space between the aerofoil 10 and the second component 11. In other words, in these arrangements, the aerofoil 10 does not have a separate bi-cast groove 17, and a portion of the channel 13 instead fulfils the function of the bi-cast groove.

In these arrangements, when the liquid bi-cast metal is poured into the space between the two components, it flows directly into the part of the channel which is blocked by the pin 12 (i.e. above the pin), without passing through a separate bi-cast groove 17 in the aerofoil.

Such arrangements may mean that the channel 13 can be formed closer to the wall of the aerofoil 10, because a separate space is not required for the bi-cast groove. This may have the advantage of increasing the area available for the main intake passage 18, which may in turn result in improved cooling of the aerofoil 10.

In some of the above arrangements, the pin 12 is secured at the closure position at least in part by contact with the bi-cast metal 15. However, arrangements are possible in which the pin 12 is not secured at the closure position by contact with the bi-cast metal.

For example, the pin 12 may be secured at the closure position by abutting part of the second component 11. In other words, contact between the aerofoil 10 and the second component 11 may secure the pin 12 in position, with the aerofoil 10 and the second component joined by the bi-cast metal.

In such arrangements, the enlarged portion into which the pin 12 is inserted may be separate from the space formed by the bi-cast groove 17 of the aerofoil and the corresponding bi-cast groove of the second component. An example of such an arrangement is shown in FIG. 16. In this arrangement, a side insert pin is used, similar to that shown in FIG. 7, but the enlarged portion 16 into which the pin 12 is inserted does not intersect the bi-cast groove 17.

When the pin 12 is inserted into the enlarged portion 16 to the closure position, and the aerofoil 10 and second component 11 are positioned adjacent to each other, one end of the pin abuts the second component 11. When the bi-cast metal 15 is poured into the space between the aerofoil 10 and the second component 11, the bi-cast metal 15 joins the aerofoil 10 and the second component 11, and the contact between the aerofoil 10, the second component 11 and the pin 12 secures the pin 12 in the closure position.

It will be appreciated that, in the arrangement shown in FIG. 16, the first component is joined to the second component by the bi-cast metal such that the pin is secured in the closure position. However, unlike the previous arrangements, the securing does not take place by means of contact between the bi-cast metal 15 and the pin 12. Such an arrangement may mean that bi-cast material does not leak into the rest of the channel 13.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of bi-casting a first component to a second component, wherein the first component comprises a channel having an opening at a surface of the component, the method comprising:
inserting a pin into the opening to a closure position to block a cross-section of said channel;
positioning the first and second components to be adjacent such that at least one space is defined between the first and second components;
pouring liquid bi-cast metal into the at least one space between the first component and the second component such that the first component is joined to the second component by the bi-cast metal and the pin is secured in the closure position.

2. The method according to claim 1, wherein the pin is secured in the closure position by contact with the bi-cast metal.

3. The method according to claim 1, wherein the opening of the channel enters an enlarged portion with a cross-section larger than the rest of the channel; and
when the pin is in the closure position, at least part of the pin is inserted into at least part of the enlarged portion.

4. The method according to claim 3, wherein the method further comprises a step of enlarging the cross-section of part of the channel to form the enlarged portion.

5. The method according to claim 3, wherein the enlarged portion includes the opening of the channel.

6. The method according to claim 3, wherein the enlarged portion intersects a region of the channel set apart from the opening of the channel.

7. The method according to claim 3, wherein a cross-section of a part of the pin abuts an end of the enlarged portion and is larger than the cross-section of the channel at the interface of the enlarged portion and the rest of the channel.

8. The method according to claim 3, wherein at least one cross-section of the pin is smaller than the cross-section of the enlarged portion of the channel, such that a void is defined between the pin and the enlarged portion when the pin is in the closure position;
wherein the void is filled by the bi-cast metal during the step of pouring.

9. The method according to claim 1, wherein the pin is inserted in a direction substantially parallel to the direction of the channel at the enlarged portion.

10. The method according to claim 1, wherein the pin is inserted in a direction transverse to the direction of the channel at the enlarged portion.

11. The method according to claim 1, wherein contact between the pin and the channel seals the channel.

12. The method according to claim 1, wherein contact between the pin, the bi-cast metal and the channel seals the channel.

13. The method according to claim 1, wherein the first component is an aerofoil.

14. A bi-cast assembly comprising:
a first component comprising a channel having an opening at a surface of the component;
a second component;
a pin; and
bi-cast metal between the first component and the second component;
wherein:
the pin is located inside the channel at a closure position to block a cross-section of said channel;
the first component is joined to the second component by the bi-cast metal, securing the pin in the closure position.

15. The bi-cast assembly according to claim 14, wherein the pin is secured in the closure position by contact with the bi-cast metal.

16. The bi-cast assembly according to claim 14, wherein the channel has an enlarged portion with a cross-section larger than the rest of the channel; and
when the pin is in the closure position, at least part of the pin is inserted into at least part of the enlarged portion.

17. The bi-cast assembly according to claim 16, wherein the enlarged portion includes the opening of the channel.

18. The bi-cast assembly according to claim 16, wherein the enlarged portion intersects a region of the channel set apart from the opening.

19. The bi-cast assembly according to claim 16, wherein the cross-section of the part of the pin which abuts the end of the enlarged portion is larger than the cross-section of the channel at the interface of the enlarged portion and the rest of the channel.

20. The bi-cast assembly according to claim 14, wherein contact between the pin and the channel seals the channel.

21. The bi-cast assembly according to claim 14, wherein contact between the pin, the bi-cast metal and the channel seals the channel.

22. The bi-cast assembly according to of claim 14, wherein the first component is an aerofoil.

23. A method of joining a first component to a second component using a joining material that can exist in at least a liquid or paste state and a solid state, wherein the first component comprises a channel having an opening at a surface of the component, the method comprising:
inserting a pin into the channel to a closure position to block a cross-section of said channel;
positioning the first and second components to be adjacent such that at least one space is defined between the first and second components;
injecting the joining material in the liquid or paste state into the at least one space between the first component and the second component such that the first component is joined to the second component and the pin is secured in the closure position once the joining material is in the solid state.

24. An assembly comprising:
a first component comprising a channel having an opening at a surface of the component;
a second component;
a pin; and
joining material between the first component and the second component;
wherein:
the pin is located inside the channel at a closure position to block a cross-section of said channel;
the first component is joined to the second component by the joining material, securing the pin in the closure position.
